(19) United States
(12) Patent Application Publication
(10) Pub. No.: US 2022/0238104 A1
(43) Pub. Date: Jul. 28, 2022

(54) AUDIO PROCESSING METHOD AND APPARATUS, AND HUMAN-COMPUTER INTERACTIVE SYSTEM

(71) Applicant: JINGDONG TECHNOLOGY HOLDING CO., LTD., Beijing (CN)

(72) Inventor: Xiaoxiao LI, Beijing (CN)

(21) Appl. No.: 17/611,741

(22) PCT Filed: May 18, 2020
(86) PCT No.: PCT/CN2020/090853

§ 371 Date: Nov. 16, 2021

(30) Foreign Application Priority Data
May 31, 2019 (CN) 201910467088.0

(51) Int. Cl. G10L 15/20; G10L 25/21; G10L 25/18; G10L 15/06; G10L 15/04; G10L 15/16; G10L 15/22; G10L 25/84; G06F 40/30; G10L 15/18; G06N 7/00

(52) U.S. Cl. CPC G10L 15/20; G10L 25/21; G10L 25/18; G10L 15/063; G10L 15/04; G06N 7/005; G10L 15/22; G10L 25/84; G06F 40/30; G10L 15/1815; G10L 15/16

(57) ABSTRACT

Disclosed are an audio processing method and device as well as a non-transitory computer readable storage medium, relating to the field of computer technology. The method comprises the following steps: determining the probability of each frame belonging to each candidate character by using a machine learning model according to the feature information of each frame in an audio to be processed; determining whether the candidate character corresponding to the maximum probability parameter of each frame is a blank character or a non-blank character, the maximum probability parameter being the maximum value of the probability of each frame belonging to each candidate character; when the candidate character corresponding to the maximum probability parameter of each frame is a non-blank character, determining the maximum probability parameter as an effective probability of the audio to be processed; and determining whether the audio to be processed is an effective speech or noise according to respective effective probabilities of the audio to be processed. The accuracy of noise determination can be improved.

### CROSS-REFERENCE TO RELATED APPLICATIONS

This application is a U.S. National Stage Application under 35 U.S.C. § 371 of International Patent Application No. PCT/CN2020/090853, filed on May 18, 2020, which is based on and claims the priority to the Chinese patent application No. 201910467088.0 filed on May 31, 2019, the disclosure of both of which is hereby incorporated as a whole into the present application.

### TECHNICAL FIELD

The present disclosure relates to the field of computer technologies, and particularly, to an audio processing method, an audio processing apparatus, a human-computer interaction system, and a non-transitory computer-readable storage medium.

### BACKGROUND

In recent years, with the continuous development of technologies, great progress has been made in human-computer intelligent interaction technologies. Intelligent speech interaction technologies are applied more and more in customer service scenes.

However, there are often various noises (e.g., voice from those people around user, environmental noises, speaker coughs, etc.) in user's surroundings. The noises are erroneously recognized as a piece of meaningless text after speech recognition, thereby interfering with semantic understanding, as a result, natural language processing fails to establish a reasonable dialog process. Therefore, the noises greatly interfere with the human-computer intelligent interaction process.

In the related art, it is determined whether an audio file is noise or effective speech generally according to audio signal's energy.

### SUMMARY

According to some embodiments of the present disclosure, there is provided an audio processing method, comprising: determining probabilities that an audio frame in a to-be-processed audio belongs to candidate characters by using a machine learning model, according to feature information of the audio frame; judging whether a candidate character corresponding to a maximum probability parameter of the audio frame is a blank character or a non-blank character, the maximum probability parameter being a maximum in the probabilities that the audio frame belongs to the candidate characters; in the case where the candidate character corresponding to the maximum probability parameter of the audio frame is a non-blank character, determining the maximum probability parameter as an effective probability that exists in the to-be-processed audio; and judging whether the to-be-processed audio is effective speech or noise, according to effective probabilities that exist in the to-be-processed audio.

In some embodiments, the judging whether the to-be-processed audio is effective speech or noise according to effective probabilities that exist in the to-be-processed audio comprises:

calculating a confidence level of the to-be-processed audio, according to a weighted sum of the effective probabilities; and judging whether the to-be-processed audio is effective speech or noise, according to the confidence level.

In some embodiments, the calculating a confidence level of the to-be-processed audio according to a weighted sum of the effective probabilities comprises: calculating the confidence level according to the weighted sum of the effective probabilities and the number of the effective probabilities, the confidence level being positively correlated with the weighted sum of the effective probabilities and negatively correlated with the number of the effective probabilities.

In some embodiments, the target audio is judged as noise in the case where the to-be-processed audio does not have an effective probability.

In some embodiments, the feature information is obtained by performing short-time Fourier transform on the audio frame by means of a sliding window.

In some embodiments, the machine learning model sequentially comprises a convolutional neural network layer, a recurrent neural network layer, a fully connected layer, and a Softmax layer.

In some embodiments, the convolutional neural network layer is a convolutional neural network having a double-layer structure, and the recurrent neural network layer is a bidirectional recurrent neural network having a single-layer structure.

In some embodiments, the machine learning model is trained by: extracting a plurality of labeled speech segments with different lengths from training data as training samples, the training data being an audio file acquired in a customer service scene and its corresponding manually labeled text; and training the machine learning model by using a connectionist temporal classification (CTC) function as a loss function.

In some embodiments, the audio processing method further comprises: in the case where the judgment result is effective speech, determining text information corresponding to the to-be-processed audio according to the candidate characters corresponding to the effective probabilities determined by the machine learning model; and in the case where the judgment result is noise, discarding the to-be-processed audio.

In some embodiments, the audio processing method further comprises: performing semantic understanding on the text information by using a natural language processing method; and determining a to-be-output speech signal corresponding to the to-be-processed audio according to a result of the semantic understanding.

In some embodiments, the confidence level is positively correlated with the weighted sum of the maximum probability parameters that audio frames in the to-be-processed audio belongs to the candidate characters, a weight of a maximum probability parameter corresponds to the blank character is 0, a weight of a maximum probability parameter of the non-blank character is 1;

the confidence level is negatively correlated with a number of maximum probability parameters corresponding to the non-blank characters.

In some embodiments, a first epoch of the machine learning model training is trained in ascending order of sample length.

In some embodiments, the machine learning model is trained using a method of Seq-wise Batch Normalization.

According to other embodiments of the present disclosure, there is provided an audio processing apparatus, comprising: a probability determination unit, configured to according to feature information of each frame in a to-be-processed audio, determine probabilities that the each frame belongs to candidate characters, by using a machine learning model; a character judgment unit, configured to judge whether a candidate character corresponding to a maximum probability parameter of the each frame is a blank character or a non-blank character, the maximum probability parameter being a maximum in the probabilities that the each frame belongs to the candidate characters; an effectiveness determination unit, configured to determine the maximum probability parameter as an effective probability in the case where the candidate character corresponding to the maximum probability parameter of the each frame is a non-blank character; and a noise judgment unit, configured to judge whether the to-be-processed audio is effective speech or noise according to effective probabilities.

According to still other embodiments of the present disclosure, there is provided an audio processing apparatus, comprising: a memory; and a processor coupled to the memory, the processor being configured to perform, based on instructions stored in the memory device, the audio processing method according to any of the above embodiments.

According to still other embodiments of the present disclosure, there is provided a human-computer interaction system, comprising: a receiving device, configured to receive a to-be-processed audio from a user; a processor, configured to perform the audio processing method according to any of the above embodiments; and an output device, configured to output a speech signal corresponding to the to-be-processed audio.

According to further embodiments of the present disclosure, there is provided a non-transitory computer-readable storage medium having thereon stored a computer program which, when executed by a processor, implements the audio processing method according to any of the above embodiments.

### BRIEF DESCRIPTION OF THE DRAWINGS

The accompanying drawings constituting a part of this specification, illustrate embodiments of the present disclosure and together with the specification, serve to explain principles of the present disclosure.

The present disclosure can be more clearly understood from the following detailed description taken with reference to the accompanying drawings, in which:

FIG. 1 illustrates a flow diagram of an audio processing method according to some embodiments of the present disclosure;

FIG. 2 illustrates a schematic diagram of step 110 in FIG. 1 according to some embodiments;

FIG. 3 illustrates a flow diagram of step 150 in FIG. 1 according to some embodiments;

FIG. 4 illustrates a block diagram of an audio processing apparatus according to some embodiments of the present disclosure;

FIG. 5 illustrates a block diagram of audio processing according to other embodiments of the present disclosure; and

FIG. 6 illustrates a block diagram of audio processing according to still other embodiments of the present disclosure.

### DETAILED DESCRIPTION

Various exemplary embodiments of the present disclosure will now be described in detail with reference to the accompanying drawings. It should be noted that: relative arrangements, numerical expressions and numerical values of components and steps set forth in these embodiments do not limit the scope of the present disclosure unless otherwise specified.

Meanwhile, it should be understood that the dimensions of the portions shown in the drawings are not drawn to actual scales for ease of description.

The following description of at least one exemplary embodiment is merely illustrative in nature and is in no way intended to limit this disclosure, and its application or uses.

Techniques, methods, and devices known to one of ordinary skill in the related art may not be discussed in detail but are intended to be part of the specification where appropriate.

In all examples shown and discussed herein, any specific value should be construed as exemplary only and not as a limitation. Thus, other examples of the exemplary embodiments can have different values.

It should be noted that: like reference numbers and letters refer to like items in the following drawings, and thus, once a certain item is defined in one drawing, it does not need to be discussed further in subsequent drawings.

Inventors of the present disclosure have found the following problems in the above related art: due to great differences in speech styles, speech volumes and surroundings with respect to different users, setting an energy judgment threshold is difficult, resulting in low accuracy of noise judgment.

In view of this, the present disclosure provides an audio processing technical solution, which can improve the accuracy of noise judgment.

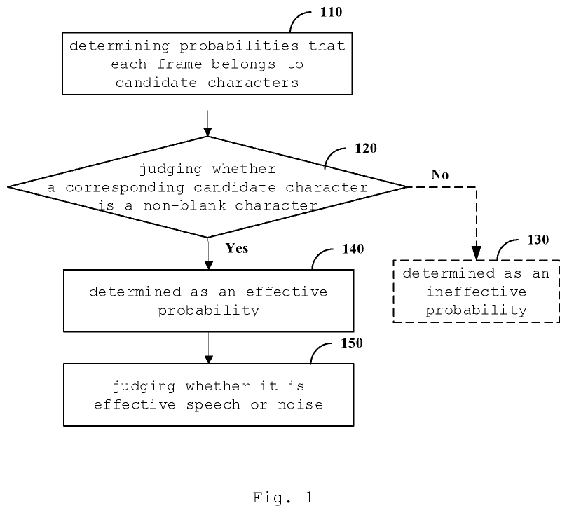

FIG. 1 illustrates a flow diagram of an audio processing method according to some embodiments of the present disclosure.

As shown in FIG. 1, the method comprises: step 110, determining probabilities that each frame belongs to candidate characters; step 120, judging whether a corresponding candidate character is a non-blank character; step 140, determined as an effective probability; and step 150, judging whether it is effective speech or noise.

In the step 110, according to feature information of each frame in a to-be-processed audio, probabilities that the each frame belongs to candidate characters are determined by using a machine learning model. For example, the to-be-processed audio can be an audio file in 16-bit PCM (Pulse Code Modulation) format with a sampling rate of 8 KHz in a customer service scene.

In some embodiments, the to-be-processed audio has T frames {1, 2, . . . t . . . T}, where T is a positive integer, and t is a positive integer less than T. The feature information of the to-be-processed audio is X={x₁, x₂, . . . xₜ . . . x_{T}}, where xₜ is feature information of the tth frame.

In some embodiments, a candidate character set can comprise common non-blank characters such as Chinese characters, English letters, Arabic numerals, punctuation marks, and a blank character <blank>. For example, the candidate character set W={w₁, w₂, . . . wᵢ . . . w_{I}}, where I is a positive integer, i is a positive integer less than I, and wᵢ is an ith candidate character.

In some embodiments, probability distribution that the tth frame in the to-be-processed audio belongs to the candidate characters is Pₜ(W|X)={pₜ(w₁|X), pₜ(w₂|X), . . . pₜ(wᵢ|X) . . . pₜ(w_{I}|X)}, where pₜ(wᵢ|X) is a probability that the tth frame belongs to wᵢ.

For example, the characters in the candidate character set can be acquired and configured according to application scenes (e.g., an e-commerce customer service scene, a daily communication scene, etc.). The blank character is a meaningless character, indicating that a current frame of the to-be-processed audio cannot correspond to any non-blank character with practical significance in the candidate character set.

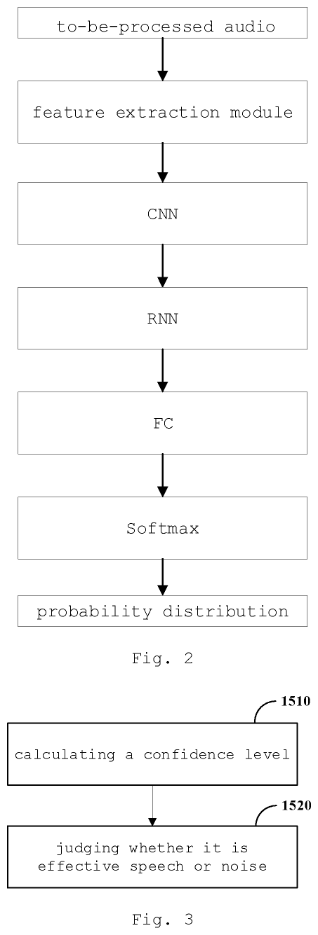

In some embodiments, the probabilities that the each frame belongs to the candidate characters can be determined by an embodiment in FIG. 2.

FIG. 2 illustrates a schematic diagram of step 110 in FIG. 1 according to some embodiments.

As shown in FIG. 2, the feature information of the to-be-processed audio can be extracted by a feature extraction module. For example, the feature information of the each frame of the to-be-processed audio can be extracted by means of a sliding window. For example, energy distribution information (Spectrogram) at different frequencies, which is obtained by performing short-time Fourier transform on a signal within the sliding window, is taken as the feature information. The size of the sliding window can be 20 ms, the sliding step can be 10 ms, and the resultant feature information can be a 81-dimensional vector.

In some embodiments, the extracted feature information can be input into the machine learning model to determine the probabilities that the each frame belongs to the candidate characters, i.e., the probability distribution of each frame with respect to the candidate characters in the candidate character set. For example, the machine learning model can comprise a CNN (Convolutional Neural Networks) having a double-layer structure, a bidirectional RNN (Recurrent Neural Network) having a single-layer structure, an FC (Full Connected layer) having a single-layer structure, and a Softmax layer. The CNN can adopt a Stride processing approach to reduce the amount of calculation of RNN.

In some embodiments, there are 2748 candidate characters in the candidate character set, then the output of the machine learning model is a 2748-dimensional vector (in which each element corresponds to a probability of one candidate character). For example, the last dimension of the vector can be a probability of the <blank> character.

In some embodiments, an audio file acquired in a customer service scene and its corresponding manually labeled text can be used as training data. For example, training samples can be a plurality of labeled speech segments with different lengths (e.g., 1 second to 10 seconds) extracted from the training data.

In some embodiments, a CTC (Connectionist Temporal Classification) function can be employed as a loss function for training. The CTC function can enable the output of the machine learning model to have a sparse spike feature, that is, candidate characters corresponding to maximum probability parameters of most frames are blank characters, and only candidate characters corresponding to maximum probability parameters of few frames are non-blank characters. In this way, the processing efficiency of the system can be improved.

In some embodiments, the machine learning model can be trained by means of SortaGrad, that is, a first epoch is trained in ascending order of sample length, thereby improving a convergence rate of the training. For example, after 20 epochs of training, a model with best performance on a verification set can be selected as a final machine learning model.

In some embodiments, a method of Seq-wise Batch Normalization can be employed to improve the speed and accuracy of RNN training.

After the probability distribution is determined, the noise judgment is continued through the steps of FIG. 1.

In the step 120, it is determined whether a candidate character corresponding to a maximum probability parameter of the each frame is a blank character or a non-blank character. The maximum probability parameter is a maximum in the probabilities that the each frame belongs to the candidate characters. For example, the maximum in pₜ(w₁|X), pₜ(w₂|X), . . . pₜ(wᵢ|X) . . . pₜ(w_{I}|X) is the maximum probability parameter of the tth frame.

In the case where the candidate character corresponding to the maximum probability parameter is a non-blank character, the step 140 is executed. In some embodiments, in the case where the candidate character corresponding to the maximum probability parameter is a blank character, step 130 is executed to determine it as an ineffective probability.

In the step 130, the maximum probability parameter is determined as the ineffective probability.

In the step 140, the maximum probability parameter is determined as the effective probability.

In the step 150, it is judged whether the to-be-processed audio is effective speech or noise according to effective probabilities.

In some embodiments, the step 150 can be implemented by an embodiment in FIG. 3.

FIG. 3 illustrates a flow diagram of step 150 in FIG. 1 according to some embodiments.

As shown in FIG. 3, the step 150 comprises: step 1510, calculating a confidence level; and step 1520, judging whether it is effective speech or noise.

In the step 1510, the confidence level of the to-be-processed audio is calculated according to a weighted sum of the effective probabilities. For example, the confidence level can be calculated according to the weighted sum of the effective probabilities and the number of the effective probabilities. The confidence level is positively correlated with the weighted sum of the effective probabilities and negatively correlated with the number of the effective probabilities.

In some embodiments, the confidence level can be calculated by:

$$α = \frac{{\sum }_{t = 1}^{T} {max}_{{w}_{i} ϵ W} {P}_{t} ( W \vert X ) \times F ( {argmax}_{{w}_{i} ϵ W} {P}_{t} ( W \vert X ) )}{{\sum }_{t = 1}^{T} F ( {argmax}_{{w}_{i} ϵ W} {P}_{t} ( W \vert X ) )}$$

where the function F is defined as

$$F ( {w}_{i} ) = \{ \begin{matrix}1 , if {w}_{i} is a non \text{-} blank character \\ 0 , if {w}_{i} is a blank character\end{matrix}$$

$${max}_{{w}_{i} ϵ W} {P}_{t} ( W \vert X )$$

denotes the maximum of Pₜ(W|X) taking wᵢ as a variable; and

$${argmax}_{{w}_{i} ϵ W} {P}_{t} ( W \vert X )$$

denotes the value of the variable wᵢ when the maximum of Pₜ(W|X) is taken.

In the above formula, the numerator is the weighted sum of the maximum probability parameters that the each frame in the to-be-processed audio belongs to the candidate characters, a weight of the maximum probability parameter corresponds to the blank character (i.e., the ineffective probability) is 0, and a weight of the non-blank character (i.e., the effective probability) corresponding to the maximum probability parameter is 1; and the denominator is the number of the maximum probability parameters corresponding to the non-blank characters. For example, in the case where the to-be-processed audio does not have an effective probability (i.e., the denominator is 0), the target audio is judged as noise (i.e., defined as α=0).

In some embodiments, different weights (for example, weights greater than 0) can also be set according to non-blank characters (for example, according to specific semantics, application scenes, importance in dialogs, and the like) corresponding to the effective probabilities, thereby improving the accuracy of noise judgment.

In the step 1520, it is judged whether the to-be-processed audio is effective speech or noise according to the confidence level. For example, in the above case, the greater the confidence level, the greater the possibility that the to-be-processed speech is judged as effective speech. Therefore, in the case where the confidence level is greater than or equal to a threshold, the to-be-processed speech can be judged as effective speech; and in the case where the confidence level is less than the threshold, the to-be-processed speech is judged as noise.

In some embodiments, in the case where the judgment result is effective speech, text information corresponding to the to-be-processed audio can be determined according to the candidate character corresponding to the effective probability determined by the machine learning model. In this way, the noise judgment and speech recognition of the to-be-processed audio can be simultaneously completed.

In some embodiments, a computer can perform subsequent processing such as semantic understanding (e.g., natural language processing) on the determined text information, to enable the computer to understand semantics of the to-be-processed audio. For example, a speech signal can be output after speech synthesis based on the semantic understanding, thereby realizing human-computer intelligent communication. For example, a response text corresponding to the semantic understanding result can be generated based on the semantic understanding, and the speech signal can be synthesized according to the response text.

In some embodiments, in the case where the judgment result is noise, the to-be-processed audio can be directly discarded without subsequent processing. In this way, adverse effects of noise on subsequent processing such as semantic understanding, speech synthesis and the like, can be effectively reduced, thereby improving the accuracy of speech recognition and the processing efficiency of the system.

In the above embodiment, the effectiveness of the to-be-processed audio is determined according to the probability that the candidate character corresponding to each frame of the to-be-processed audio is a non-blank character, and then whether the to-be-processed audio is noise is judged. In this way, the noise judgment performed based on the semantics of the to-be-processed audio can better adapt to different speech environments and speech volumes of different users, thereby improving the accuracy of noise judgment.

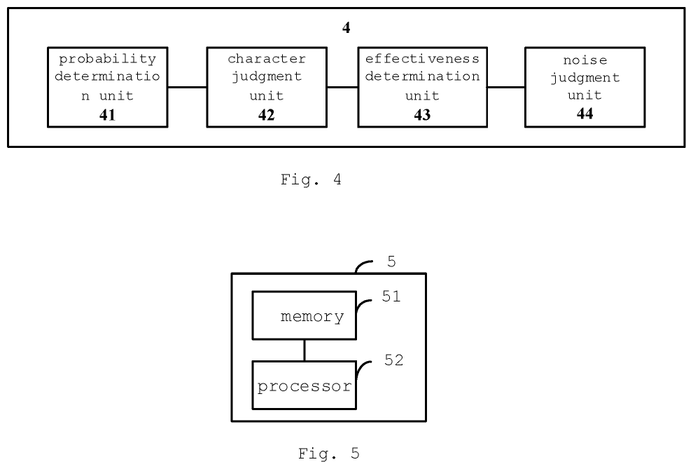

FIG. 4 illustrates a block diagram of an audio processing apparatus according to some embodiments of the present disclosure.

As shown in FIG. 4, the audio processing apparatus 4 comprises a probability determination unit 41, a character judgment unit 42, an effectiveness determination unit 43, and a noise judgment unit 44.

The probability determination unit 41 determines, according to feature information of each frame in a to-be-processed audio, probabilities that the each frame belongs to candidate characters, by using a machine learning model. For example, the feature information is obtained by performing short-time Fourier transform on the each frame by means of a sliding window. The machine learning model can sequentially comprise a convolutional neural network layer, a recurrent neural network layer, a fully connected layer, and a Softmax layer.

The character judgment unit 42 judges whether a candidate character corresponding to a maximum probability parameter of the each frame is a blank character or a non-blank character. The maximum probability parameter is a maximum of the probabilities that the each frame belongs to the candidate characters.

In the case where the candidate character corresponding to the maximum probability parameter of the each frame is a non-blank character, the effectiveness determination unit 43 determines the maximum probability parameter as an effective probability. In some embodiments, in the case where the candidate character corresponding to the maximum probability parameter of the each frame is a blank character, the effectiveness determination unit 43 determines the maximum probability parameter as an ineffectiveness probability.

The noise judgment unit 44 judges whether the to-be-processed audio is effective speech or noise based on effective probabilities. For example, in the case where the to-be-processed audio does not have an effective probability, the target audio is judged as noise.

In some embodiments, the noise judgment unit 44 calculates a confidence level of the to-be-processed audio according to a weighted sum of the effective probabilities. The noise judgment unit 44 judges whether the to-be-processed audio is effective speech or noise according to the confidence level. For example, the noise judgment unit 44 calculates the confidence level according to the weighted sum of the effective probabilities and the number of the effective probabilities. The confidence level is positively correlated with the weighted sum of the effective probabilities and negatively correlated with the number of the effective probabilities.

In the above embodiment, the effectiveness of the to-be-processed audio is determined according to the probability that the candidate character corresponding to the each frame of the to-be-processed audio is a non-blank character, and then whether the to-be-processed audio is noise is judged. In this way, noise judgment performed based on semantics of the to-be-processed audio, can be better adapt to different speech environments and speech volumes of different users, thereby improving the accuracy of noise judgment.

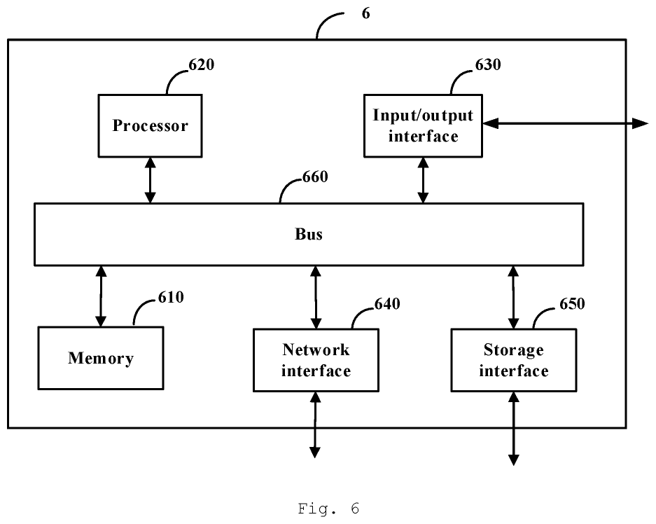

FIG. 5 shows a block diagram of audio processing according to other embodiments of the present disclosure.

As shown in FIG. 5, the audio processing apparatus 5 of this embodiment comprises: a memory 51 and a processor 52 coupled to the memory 51, the processor 52 being configured to perform, based on instructions stored in the memory 51, the audio processing method according to any of the embodiments of the present disclosure.

The memory 51 therein can comprise, for example, a system memory, a fixed non-transitory storage medium, and the like. The system memory has thereon stored, for example, an operating system, an application, a Boot Loader, a database, other programs, and the like.

FIG. 6 illustrates a block diagram of audio processing according to still other embodiments of the present disclosure.

As shown in FIG. 6, the audio processing apparatus 6 of this embodiment comprises: a memory 610 and a processor 620 coupled to the memory 610, the processor 620 being configured to perform, based on instructions stored in the memory 610, the audio processing method according to any of the above embodiments.

The memory 610 can comprise, for example, a system memory, a fixed non-transitory storage medium, and the like. The system memory has thereon stored, for example, an operating system, an application, a Boot Loader, other programs, and the like.

The audio processing apparatus 6 can further comprise an input/output interface 630, a network interface 640, a storage interface 650, and the like. These interfaces 630, 640, 650 and the memory 610 can be connected with the processor 620, for example, through a bus 660, wherein, the input/output interface 630 provides a connection interface for input/output devices such as a display, a mouse, a keyboard, a touch screen, a microphone, and a speaker. The network interface 640 provides a connection interface for a variety of networking devices. The storage interface 650 provides a connection interface for external storage devices such as an SD card and a USB flash disk.

According to still other embodiments of the present disclosure, there is provided a human-computer interaction system, comprising: a receiving device, configured to receive a to-be-processed audio from a user; a processor, configured to perform the audio processing method according to any of the above embodiments; and an output device, configured to output a speech signal corresponding to the to-be-processed audio.

As will be appreciated by one of skill in the art, embodiments of the present disclosure can be provided as a method, system, or computer program product. Accordingly, the present disclosure can take the form of an entire hardware embodiment, an entire software embodiment or an embodiment combining software and hardware aspects. Furthermore, the present disclosure can take the form of a computer program product implemented on one or more computer-usable non-transitory storage media (comprising, but not limited to, a disk memory, CD-ROM, optical memory, etc.) having computer-usable program code embodied therein.

So far, an audio processing method, an audio processing apparatus, a human-computer interaction system, and a non-transitory computer-readable storage medium according to the present disclosure have been described in detail. Some details well known in the art have not been described in order to avoid obscuring the concepts of the present disclosure. Those skilled in the art can now fully appreciate how to implement the technical solution disclosed herein, in view of the foregoing description.

The method and system of the present disclosure can be implemented in a number of ways. For example, the method and system of the present disclosure can be implemented in software, hardware, firmware, or any combination of the software, hardware, and firmware. The above sequence of steps of the method is for illustration only, and the steps of the method of the present disclosure are not limited to the sequence specifically described above unless otherwise specifically stated. Further, in some embodiments, the present disclosure can also be implemented as programs recorded in a recording medium, these programs comprising machine-readable instructions for implementing the method according to the present disclosure. Thus, the present disclosure also covers the recording medium having thereon stored the programs for performing the method according to the present disclosure.

Although some specific embodiments of the present disclosure have been described in detail by means of examples, it should be understood by those skilled in the art that the above examples are for illustration only and are not intended to limit the scope of the present disclosure. It should be appreciated by those skilled in the art that modifications can be made to the above embodiments without departing from the scope and spirit of the present disclosure. The scope of the present disclosure is defined by the attached claims.

1. An audio processing method, comprising:
determining probabilities that an audio frame in a to-be-processed audio belongs to candidate characters by using a machine learning model, according to feature information of the audio frame;
judging whether a candidate character corresponding to a maximum probability parameter of the audio frame is a blank character or a non-blank character, the maximum probability parameter being a maximum in the probabilities that the audio frame belongs to the candidate characters;
in the case where the candidate character corresponding to the maximum probability parameter of the audio frame is a non-blank character, determining the maximum probability parameter as an effective probability that exists in the to-be-processed audio; and
judging whether the to-be-processed audio is effective speech or noise, according to effective probabilities that exist in the to-be-processed audio.

2. The audio processing method according to claim 1, wherein the judging whether the to-be-processed audio is effective speech or noise according to effective probabilities that exist in the to-be-processed audio comprises:
calculating a confidence level of the to-be-processed audio, according to a weighted sum of the effective probabilities; and
judging whether the to-be-processed audio is effective speech or noise, according to the confidence level.

3. The audio processing method according to claim 2, wherein the calculating a confidence level of the to-be-processed audio, according to a weighted sum of the effective probabilities comprises:
calculating the confidence level, according to the weighted sum of the effective probabilities and the number of the effective probabilities, the confidence level being positively correlated with the weighted sum of the effective probabilities and negatively correlated with the number of the effective probabilities.

4. The audio processing method according to claim 1, further comprising:
judging the target audio as noise in the case where the to-be-processed audio does not have an effective probability.

5. The audio processing method according to claim 1, wherein the feature information is energy distribution information at different frequencies, which is obtained by performing short-time Fourier transform on the audio frame by means of a sliding window.

6. The audio processing method according to claim 1, wherein the machine learning model sequentially comprises a convolutional neural network layer, a recurrent neural network layer, a fully connected layer, and a Softmax layer.

7. The audio processing method according to claim 6, wherein the convolutional neural network layer is a convolutional neural network having a double-layer structure, and the recurrent neural network layer is a bidirectional recurrent neural network having a single-layer structure.

8. The audio processing method according to claim 1, wherein the machine learning model is trained by:
extracting a plurality of labeled speech segments with different lengths from training data as training samples, the training data being an audio file acquired in a customer service scene and its corresponding manually labeled text; and
training the machine learning model by using a connectionist temporal classification (CTC) function as a loss function.

9. The audio processing method according to claim 1, further comprising:
in the case where the judgment result is effective speech, determining text information corresponding to the to-be-processed audio, according to the candidate characters corresponding to the effective probabilities; and
in the case where the judgment result is noise, discarding the to-be-processed audio.

10. The audio processing method according to claim 9, further comprising:
performing semantic understanding on the text information by using a natural language processing method; and
determining a to-be-output speech signal corresponding to the to-be-processed audio according to a result of the semantic understanding.

11. A human-computer interaction system, comprising:
a receiving device, configured to receive a to-be-processed audio sent by a user;
a processor, configured to perform the audio processing method according to claim 1; and
an output device, configured to output a speech signal corresponding to the to-be-processed audio.

12. (canceled)

13. An audio processing apparatus, comprising:
a memory; and
a processor coupled to the memory, the processor being configured to perform, based on instructions stored in the memory device, the audio processing method according to claim 1.

14. A non-transitory computer-readable storage medium having thereon stored a computer program which, when executed by a processor, implements the audio processing method according to claim 1.

15. The audio processing method according to claim 3, wherein:
the confidence level is positively correlated with the weighted sum of the maximum probability parameters that audio frames in the to-be-processed audio belongs to the candidate characters, a weight of a maximum probability parameter corresponds to the blank character is 0, a weight of a maximum probability parameter of the non-blank character is 1;
the confidence level is negatively correlated with a number of maximum probability parameters corresponding to the non-blank characters.

16. The audio processing method according to claim 8, wherein a first epoch of the machine learning model training is trained in ascending order of sample length.

17. The audio processing method according to claim 6, wherein the machine learning model is trained using a method of Seq-wise Batch Normalization.
